(19) United States
(12) Patent Application Publication
(10) Pub. No.: US 2013/0271277 A1
(43) Pub. Date: Oct. 17, 2013

(54) PERSONAL SECURITY DEVICE

(71) Applicant: Michele McCauley, Boca Raton, FL (US)

(72) Inventor: Michele McCauley, Boca Raton, FL (US)

(21) Appl. No.: 13/914,567

(22) Filed: Jun. 10, 2013

Related U.S. Application Data
(63) Continuation-in-part of application No. 13/134,673, filed on Jun. 15, 2011, now abandoned.

(51) Int. Cl. G08B 7/06

(52) U.S. Cl. CPC G08B 7/06
USPC 340/517

(57) ABSTRACT

A security device with a locator module and an identifier module sends an alert signal to warn others of an emergency situation. The security device uses a wireless transceiver to transmit the alert signal and a monitoring center. Location information updates and an audio signal are sent to the monitoring station. The security device may be located within an outer casing that conceals its functionality.

### CROSS-REFERENCE TO RELATED APPLICATIONS

This Utility Patent Application is a continuation-in-part of U.S. patent application Ser. No. 12/558, 217 filed on Sep. 11, 2009 and claims priority to U.S. Provisional Application No. 61/191,873 filed Sep. 13, 2008 the entirety of which is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD

The present invention relates to a personal security device that allows an individual to inconspicuously report an emergency situation and for inconspicuous observation of an emergency or other situation. The invention provides the location of the person in distress and allows audio and/or video monitoring of the emergency situation. The invention may also be used to monitor the location and activities of a person.

### BACKGROUND

Despite extensive security measures, a robust police system and numerous security companies, personal safety remains a serious issue in today's society. Robbery and kidnapping occur with alarming frequency. Every year we hear of numerous incidents of kidnappings, murders and sexual assaults. Victims are often women and children unable to escape from an armed and dangerous assailant. Too often we hear of girls new to college assaulted on campus. Women and children are abducted from mall parking lots. Even in neighborhoods children may be picked up by strangers tempting them with candy or other treats. Awareness of these dangers is often insufficient protection. An armed assailant may easily force a victim into his car with only the threat of violence.

Assailants are often mentally unstable and a victim's risk of injury in their custody is increased by attempts to escape or call for help. Use of defensive devices such as pepper spray offer an opportunity to escape but also run the risk of angering an assailant and incurring his or her wrath. More effective deterrents such as fire arms are not a desirable solution as they only increase the level of violence in our society. The victim is less likely to be harmed during the initial contact with an assailant if he or she puts up little resistance.

The most preferred way of handling a dangerous assault situation is to promptly alert authorities skilled in confronting dangerous criminals and rescuing victims. As a result, a number of methods have been developed that allow a person to alert authorities of a dangerous or harmful situation. The most obvious method is to use a cellular telephone to call police. These communication devices have long since become a staple gadget in our society. However, it is impractical to attempt to call authorities after an assault. An assailant may merely take away a cell phone and dispose of it.

Many devices have been developed to send an emergency signal to indicate that a person is in distress. Cell phones themselves may have a speed dial number or even a button particularly programmed to directly call authorities. However, such a device is impractical to the victim of a kidnapper or sexual molester. Such emergency call methods are well known and it is unlikely that an assailant will allow a victim to operate a cell phone once abducted. Other well known methods include a ‘panic button’ on a necklace or similar device in radio communication with a transceiver that is connected to a telephone or similar network. These devices are compact, but have a very limited range.

Other devices, designed for persons far from civilization, such as when camping or hiking, send a distress signal via satellite. They are typically bulky due to a relatively large battery as required for long term usage. They are also extremely rugged to survive difficult terrain and circumstances. Their use of satellites to communicate and determine location is ideal for wilderness environments, but not necessarily reliable in an urban environment where a user may not have direct line of sight to satellites. They are also impractical to carry inconspicuously and/or in a pocket.

Other devices are smaller and better suited for personal day to day carrying and use. However, these devices often are still tied to a transceiver that must be located nearby. Other devices either send no signal to the user confirming receipt of the alert message, or send a confirmation signal that is likely to be noticed by an assailant.

It is therefore desirable to provide a quick and inconspicuous way to convey an alert and provide tracking capabilities for authorities during a hazardous situation.

It is also desirable to provide a device that allows a parent, probation officer or other person acting as guardian or standing in loco parentis to monitor a person's activities.

### SUMMARY

Accordingly, the primary object of the present invention is to provide a security device having a control module, a transceiver in communication with the control module, the transceiver operable for sending and receiving signals, a trigger in communication with the control module, the trigger operable to actuate transmission of a signal by the transceiver, a location module in communication with the control module, the location module identifying a location of the security device and a microphone coupled to the control module. The control module, transceiver, trigger, location module and microphone are optionally disposed within an outer concealment casing. A confirmation indicator is optionally in communication with the control module and conveys a confirmation signal when the transceiver receives a receipt signal. The confirmation indicator provides a vibrating response to indicate that the receipt signal has been received. Optionally, the confirmation indicator includes an illuminating device. The confirmation indicator may include an audio device. The transceiver sends an alert signal including a device identifier, a location of the security device and an audio signal upon actuation of the trigger. Optionally, the security device also comprises a cover slidably positionable about the trigger. The location module may include a Global System for Mobile device, a Global Positioning System device and/or an Assisted Global Positioning System device. The transceiver may include a Subscriber Identity Module.

A security device may comprise a case, a rechargeable power supply within the case, a verification switch at least partially disposed within the case, a trigger coupled to the case, a cover slidably positionable over the trigger, an assisted global positioning system location module disposed within the case, a microphone coupled to the case, a transceiver disposed within the case, the transceiver including a Subscriber Identity Module and a vibrating confirmation indicator disposed within the case. The security device may further comprise a concealment casing surrounding at least a portion of the case.

A method for summoning emergency assistance comprises providing a security device comprising a location module, a device identifier module, a transceiver, a trigger, a confirmation indicator and a microphone, activating the trigger, where activation of the trigger actuates the transceiver to send an alert signal including a security device identity, a security device location and an audio signal to a monitoring station, transmitting a receipt signal form the monitoring station to the transceiver and actuating the confirmation indicator upon receipt of the receipt signal. The method may additionally comprise contacting an emergency assistance provider. The method may optionally also comprise impinging a verification switch to verify that the security device is functioning properly. Activating the trigger may include depressing the trigger for a predetermined length of time. Activating the trigger may include depressing the trigger until the security device receives the receipt signal. Activating the trigger may include depressing the trigger a plurality of times.

It is therefore an object of the present invention to provide a device and system for allowing a person to notify others of an emergency situation and to allow monitoring of the situation. It is also an object of the invention to allow another person to monitor the activities of another person.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an envelope and dental cleaning devices of the invention in an open position;

FIG. 2 is a perspective view of an envelope and dental cleaning devices of the invention in a closed position;

FIG. 3 is a side elevational view of an envelope and dental cleaning devices of the invention;

FIG. 4 is a top plan view of a dental cleaning device of the invention;

FIG. 5 is a perspective view of an alternative envelope and dental cleaning devices of the invention;

FIG. 6 is a perspective view of an alternative envelope and dental cleaning devices of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

A security device in accordance with the principles of the invention may be preferably small and inconspicuous. It may be easily disguisable as a key fob, pendant, or similar object, and may be constructed of durable, waterproof material. It may have a trigger the operator actuates in order to send an alert signal. The trigger may be a button which the operator depresses for a period of time, for example three seconds. This prevents accidental activation of the trigger when the device is stored in a pocket, purse, or similar location. Alternatively, the trigger may require two or more steps to actuate. For example, the trigger may have a cover that must first be slid out of the way. Alternatively, the trigger may require several turns or rotations in place of or in addition to being pressed. The security device is optionally powered by a rechargeable battery.

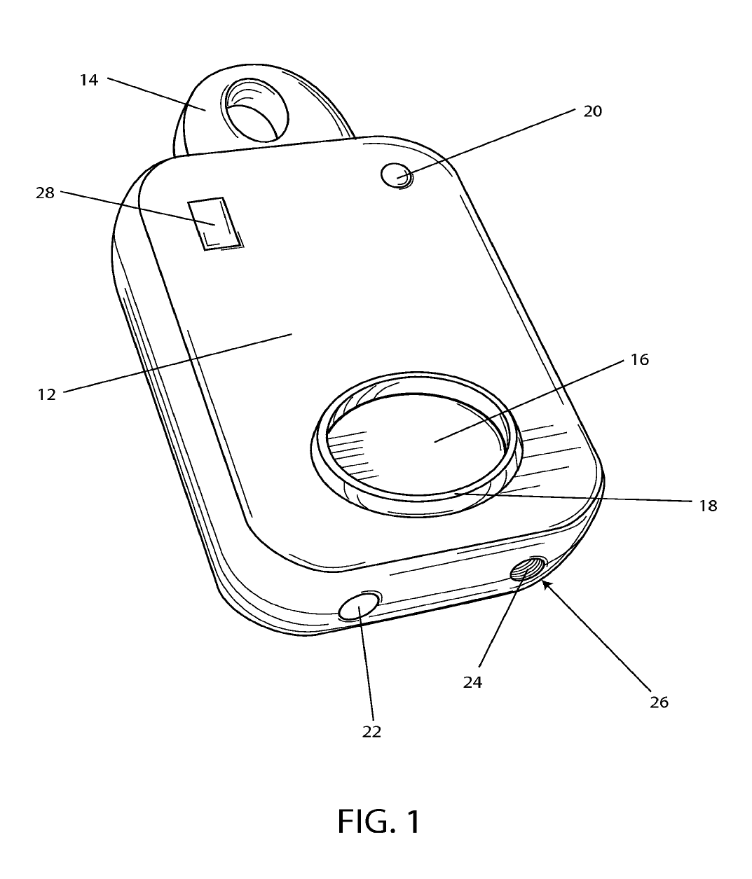

FIG. 1 shows an exemplary security device 10 of the present invention. Security device 10 may be similar in size and appearance to a common car lock key fob and contained within case 12. Case 12 may be preferably made from hard plastic or a similar material. Case 12 may also be preferably water resistant. This embodiment of the security device 10 is relatively inconspicuous and easily fits within an operator's pocket and preferably includes lanyard loop 14 for attachment to a keychain or other lanyard. The case 12 may contain several internal components including a control modue, a location module, a microphone, a camera, an accelerometer and a transceiver. In use the transceiver may send an emergency alert signal to a remote monitoring station (not shown) which then may monitor the location of the device 10 and may record an audio or video signal from the device to determine whether a true emergency exists.

The invention is a relatively nondescript device having relatively few visible components. This makes the device less conspicuous. Trigger 16 may be recessed and may further include a rim 18 surrounding the trigger 16 to decrease the likelihood of accidental depression of trigger 16. In this embodiment, trigger 16 may be activated by applying a predetermined impingement pattern to the trigger 16. The predetermined impingement pattern may be continuously depressing trigger 16 for an extended time period, optionally about 3-5 seconds, pressing the trigger 16 three to five consecutive times, or other suitable and easily recognizable patterns. Because the alarm trigger is only activated by the predetermined impingement pattern, accidental triggering may be prevented. When the trigger 16 is activated, an alert signal may be initiated.

Security device 10 may optionally include a confirmation indicator. The confirmation indicator may be actuated upon receipt of a confirmation signal sent by a monitoring station that receives an alert signal sent by the device. The confirmation indicator may convey to the operator that the alert signal sent by the device has been received by the monitoring station. This embodiment includes a visual indicator 20 as a confirmation indicator. Indicator 20 may be an LED or other similar light emitting device. The confirmation signal may include the illumination of visual indicator 20. Optionally, an audio indicator may be used to convey a confirmation signal. The device optionally may include only a haptic signaling mechanism, i.e. a vibrating mechanism such as those commonly provided with cellular phones. A haptic mechanism may be preferred for providing the confirmation signal as a vibration is less conspicuous than a light or sound. Alternatively, all three signal mechanisms, a vibrator, a visual indicator and an audio signal device may be included and either the bearer of the device 10 or the monitoring station may select the type of confirmation signal provided.

Security device 10 may also include a recharging jack 22. Recharging jack 22 allows the device 10 to be connected to a battery recharger. The invention preferably includes a rechargeable power supply. Optionally, the invention may be designed to run on a replaceable battery. However, a rechargeable supply is preferred as it is more compatible with a securely enclosed and water resistant case. Those skilled in the art will appreciate that the recharging jack 22 may be replaced with recharging pads. Any power supply is suitable for the device so long as it is compact and capable of being recharged.

In one embodiment, a device 10 also includes a recessed verification switch 24. Verification switch 24 is a small button located within a small opening 26 and is only accessible using a small tool such as a paperclip. Depressing this switch 24 actuates the confirmation signal, verifying that the device is charged and operating properly. Optionally, depressing verification switch 24 may also be a reset and/or reboot switch which may restart software or firmware of the device.

Device 10 may also include a microphone 28 for monitoring the potential emergency situation surrounding the device. The microphone 28 may be inconspicuous and allow the device to receive and transmit any conversation, dialogue or other sounds in the immediate vicinity of the device.

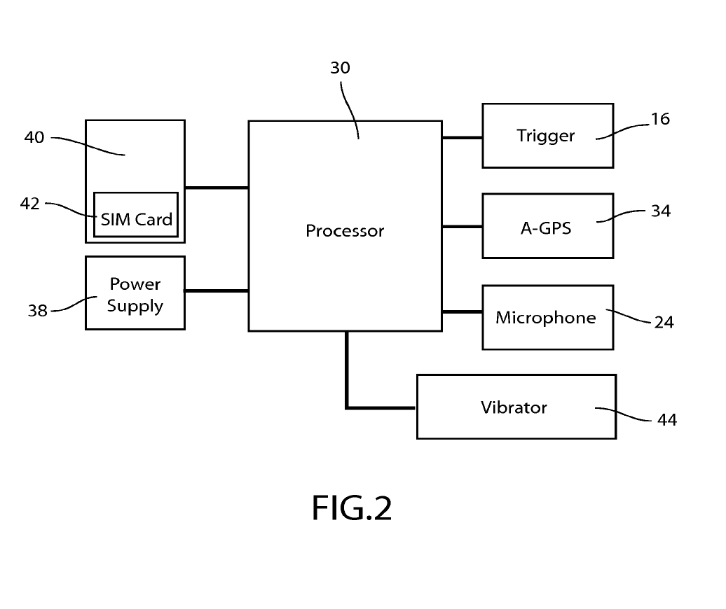

FIG. 2 shows a schematic diagram of an embodiment of the invention. In this embodiment, a central processor 30 controls the security device. It is powered by power supply 38. Power supply 38 provides power for all of the electrical components of the security device. Although in this schematic diagram power supply 38 is shown connected to central processor 30, those skilled in the art will appreciate that it may provide power directly to individual components and/or include a power distribution component.

Trigger 16 may also be connected to central processor 30. Processor 30 identifies when the trigger has been properly activated. Microphone 28 is also connected to processor 30. Microphone 28 is preferably very sensitive to enhance reception even when device 30 is in a pocket or purse. Location module 34 provides processor 30 with the location of the device. An A-GPS (Assisted Global Positioning System) circuit is preferred as it combines positioning by both GPS and cell tower triangulation. However, a standard Global Positioning System (GPS), Global System for Mobile (GSM), cell tower triangulation device or other locating method may also be used by the locator module 34 to determine the location of the device. The location module allows the device to accurately identify its location. Inside buildings and in parking decks, pure GPS devices may not have a line of sight to satellites and therefore function poorly. A GPS may therefore be preferred because it also uses the cell phone tower network to identify its location and therefore is better suited for an urban environment.

Processor 30 is also connected to a transceiver 40. Transceiver 40 is preferably a compact device that contacts the monitoring station 52 by means of satellite, via one or more wireless networks or other means of contacting the monitoring station 52. Transceiver 40 includes an identifier module 42 that provides an identity for the security device and allows a monitoring station 52 to immediately identify the source of the alert signal upon receipt. In this embodiment, the identifier module 42 may comprise a Subscriber Identity Module (SIM) card, but any identifying signal may be used by the device.

In one embodiment, a monitoring station sends a signal acknowledging connection to the device and receipt of the alert signal. The device then provides a discrete confirmation signal to notify the operator that the monitoring station is aware of the emergency situation. The monitoring station then listens to an audio signal provided by the device to ascertain whether a true emergency has occurred and which authorities to contact. Optionally, the monitoring station listens for the operator to utter code words that inconspicuously notify the monitoring station of the nature of the situation. Optionally, the operator may press the trigger button in a certain pattern to indicate different types of situations. For example, morse code could be used to depress the trigger in a pattern the monitoring station may recognize. If a true emergency is occurring, the monitoring station notifies the police or other authorities. If the alert signal was sent by mistake, the monitoring station confirms a false alarm with the operator.

Optionally, a monitoring station 52 may “ping” the device so as to determine its location even when there is no known emergency, and with or without notifying the operator that a “ping” has occurred. As used here, when the device is “pinged” a pinging signal is sent from the monitoring station and, if the device receives the pinging signal, it will send a return ping signal. Thus the monitoring station may verify that the device is operation properly. Optionally, the device 10 may automatically send a signal at predetermined time intervals to monitoring station 52. If the monitoring station 52 fails to receive a schedule automatic signal or a return ping from the device 10, it may provide an alert to the agent 54 or to another receiver, for example another person or another person's cell phone or computer. When trigger 30 is activated, processor 30 instructs transceiver 40 to call the monitoring station 52 and provide the device's identification and location as determined by the location module 34. The Processor 30 also may also provide the audio signal recorded by microphone 28 to transceiver 40 to be transmitted over the network when requested by the monitoring station. When the transceiver receives a receipt signal from the monitoring station, processor 30 may create a confirmation signal by actuating the confirmation indicator 44. FIG. 2 shows a confirmation indicator 44 comprising a vibrating device. Optionally, processor 30 may also create a confirmation signal by illuminating a visual indicator such as the LED in FIG. 1.

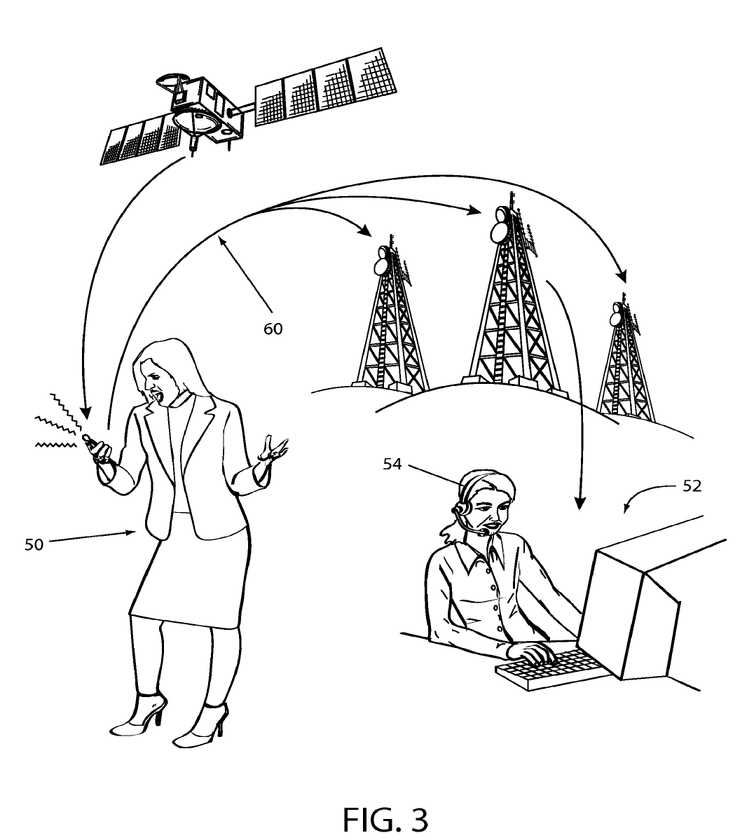

FIG. 3 shows an environmental view of an operator 50 carrying security device 10. Upon realizing that she is in an emergency situation, operator 50 may activate the trigger 16 of the security device. Activation of the trigger 16 may initiate a sequence of events resulting in the sending of an alert signal. Immediately, processor 30 may request location data from the locator circuit 34. Locator circuit 34 may determine the location of the device using GPS, cell tower triangulation or both or other means for determining location and may provide the information to processor 30. Processor 30 may send the location information to the transceiver 40 which may then transmit the alert signal 60 to monitoring station 52. The alert signal 60 may comprise the device's location and identity and an audio signal, a video signal or other information. Alert signal 60 may travel over a a satellite system, a cellular phone network or other means to monitoring station 52. When monitoring agent 54 receives the alert signal, he or she may send a receipt signal to the device. Optionally, the monitoring station 52 may include software that automatically transmits the receipt signal upon receipt of the alert signal. The device may optionally then provide a confirmation signal to the operator in the form of a vibration, a visual signal, an audio signal or a combination of thereof. The device 10 may then provide regular updates of its location and audio, video or other signal to the monitoring station. The monitoring agent 54 may listen to the audio signal from the device to determine whether the alarm signal was sent accidentally or whether a true emergency situation exists.

Optionally, the device 10 may send only an alert signal upon activation. The monitoring station 52 may then request the location and audio information from the device 10. Optionally, the monitoring agent 54 may listen for specific code words chosen at an earlier time that indicate the nature of the emergency. Further, if the operator has no need to be discrete, the operator may simply tell the monitoring station agent 54 what the nature of the emergency is. However, one of the features of the invention is that an assailant may not readily discern that an alert signal has been transmitted. In this situation, the operator may wish to avoid revealing the nature of the security device and not speak directly to the monitoring agent 54.

If the monitoring agent 54 determines that a true emergency situation has arisen, the agent may notify the proper authorities, such as police, fire or rescue officers of the location and any information gleaned from listening to the audio signal or by viewing a video signal. In this manner, authorities can be notified of an emergency situation and help may be sent to the operator without an assailant knowing that the victim has taken any steps to acquire assistance. The confirmation signal inconspicuously provides the operator with the security of knowing that his or her distress call has been received and that assistance is on the way.

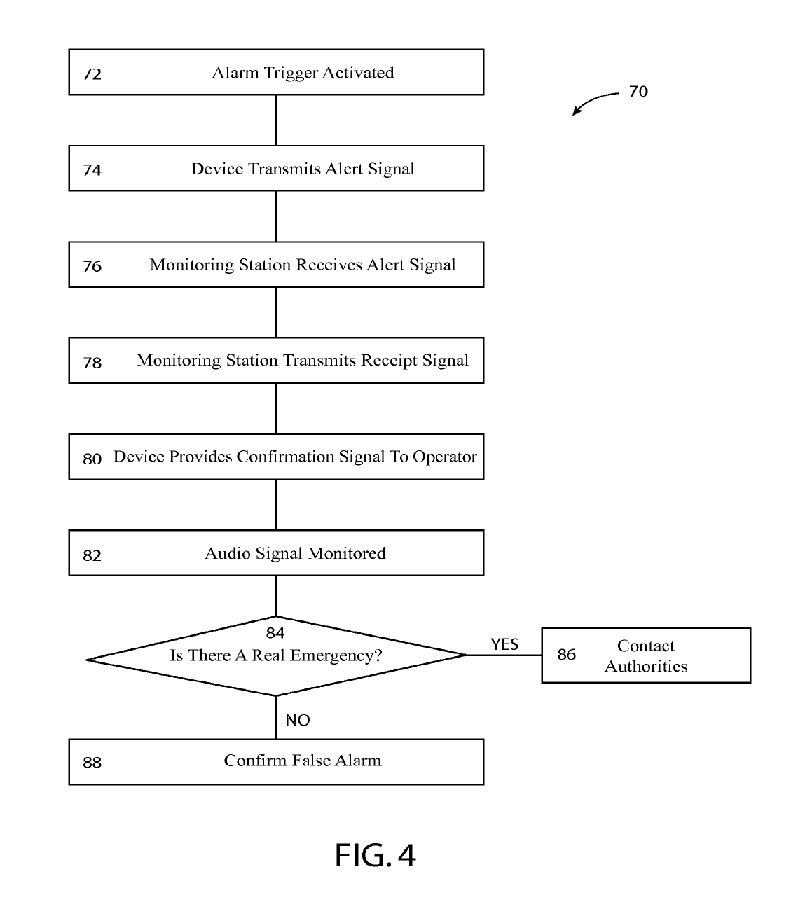

Referring to FIG. 4, flow chart 70 shows how the security device of the present invention is used. The alarm trigger may be activated 72, causing the device to send an alert signal 74 to the monitoring station. The monitoring station may then receive the alert signal 76. The alert signal includes with it the location of the device as determined by the locator circuit. The monitoring station also identifies the device by its SIM card or other identifying means. This allows the monitoring station to readily determine the identity and location of the person sending the alert signal. The device 10 may also send the audio signal received from a microphone or images from a camera.

The monitoring station may then transmit a receipt signal 78 back to the security device. Once the security device receives the receipt signal, it may convey a confirmation signal 80 to the recipient. As explained, a confirmation signal is preferably inconspicuous, comprising a vibration and/or visual indicator and/or an audio indicator. The monitoring station continues to monitor the audio signal from the security device to ascertain the nature of the potential emergency. The monitoring station may make a determination 84 as to whether a real emergency exists or the security device was accidentally triggered. If the monitoring station concludes that the device was accidentally triggered 88, then the monitoring station may optionally call via telephone to confirm that there is no emergency and may send a second confirmation signal or a separate signal indicating that the alert signal has been dismissed as not an authentic emergency. If the monitoring station determines that there is a true emergency 86, it will notify the appropriate authorities, including the police or an emergency rescue team.

The device may provide other functions as well. For example, the device may include an accelerometer, or may measure speed and acceleration using GPS or other location determining mechanisms. When the device detects a speed in excess of a predetermined limit, such as a speed limit, it may send a signal to the monitoring station, or directly to a second party, for example a parent, by email, text message or an alert notification, for example on a smart phone application. This allows a parent to monitor a child, for example a teenager, to ensure that they are behaving responsibly. It may be desirable for notifications relating to excessive speed are relayed only to a second party, i.e. a parent, so as not to overwhelm a monitoring station more concerned with preventing crime. Optionally, the device may provide a warning signal, such as a vibration or an audio warning, to the operator to advise him or her that if speed is not reduced it will be reported.

Use of an accelerometer may also be utilitzed to indicate a possible accident. The location of the device may be monitored constantly, at e.g. 5 second intervals, or continuously. A monitoring station 52 monitoring the device could signal a possible emergency when extreme change in speed, from fast to stopped, occur. When such an acceleration change is noticed, a signal could be sent or the monitoring station 52 could be alerted by the software, to investigate and ensure the bearer of the device is not injured.

In addition, monitoring station may use software to interact with or monitor the device continuously or at intervals the location of the device and may be used in a variety of ways. The monitoring station 52 may include software which may be located on a computer system of the monitoring station 52. A human operator and/or software at the monitoring station may perform some or all of the functions at the monitoring station. A human operator may act as a redundancy to the software, verifying performance of some or all of the software's functions. The monitoring station may identify certain geographic locations that may be virtually cordoned off such that the station generates an alert signal when a particular device has entered a cordoned off region. For example, a parent may wish his or her child to not enter a certain part of town. The monitoring station may be programmed to generate an alert and send it to a parent if the device enters the undesired area. Alternatively, the monitoring station may merely note the entry into a cordoned off area and include it with any other information supplied to an agent 54 who may then make a judgment call as to whether any action need be taken.

Similarly, as mentioned above, monitoring station may alert a parent when the device exceeds certain speeds. The monitoring station may also send a signal if the device travels a certain distance away from a home or other location. The monitoring station may also send a signal if the device is turned off. These various alerts generated by the software while monitoring the device may be sent to a certain party, for example, a parent, and/or may be used for determining whether any action may be required by the monitoring station. The monitoring station or the parent may optionally turn off and turn on both a microphone and a camera on the device. This may allow for random monitoring of the device's surroundings. Thus, in addition to being purely a security device to alert authorities of emergency situations, the device may also be used by parents to better monitor their children.

Monitoring software may also be utilized to continuously or sporadically monitor audio and/or video signals from the device. In this way, the monitoring software could monitor for particular sounds or images. For example, the monitoring software could be programmed to identify various voice patterns. Thus, the software could send an alert if it recognizes the voice of a particular individual or particular words being spoken.

The monitoring station 52 may be comprised of both monitoring software and a monitoring agent 54. The monitoring station 52 may have software that automatically requests information from the device when a) an alert signal is received from the device, b) there is a substantial change in the speed of the device, c) the device enters a geographic region that has been cordoned off, d) the device does not provide the predetermined automated periodic check-in signal, e) the device signals that a particular sound, word or speech pattern has been detected by the microphone. Optionally, the monitoring agent 54 may perform some, all or none of these functions.

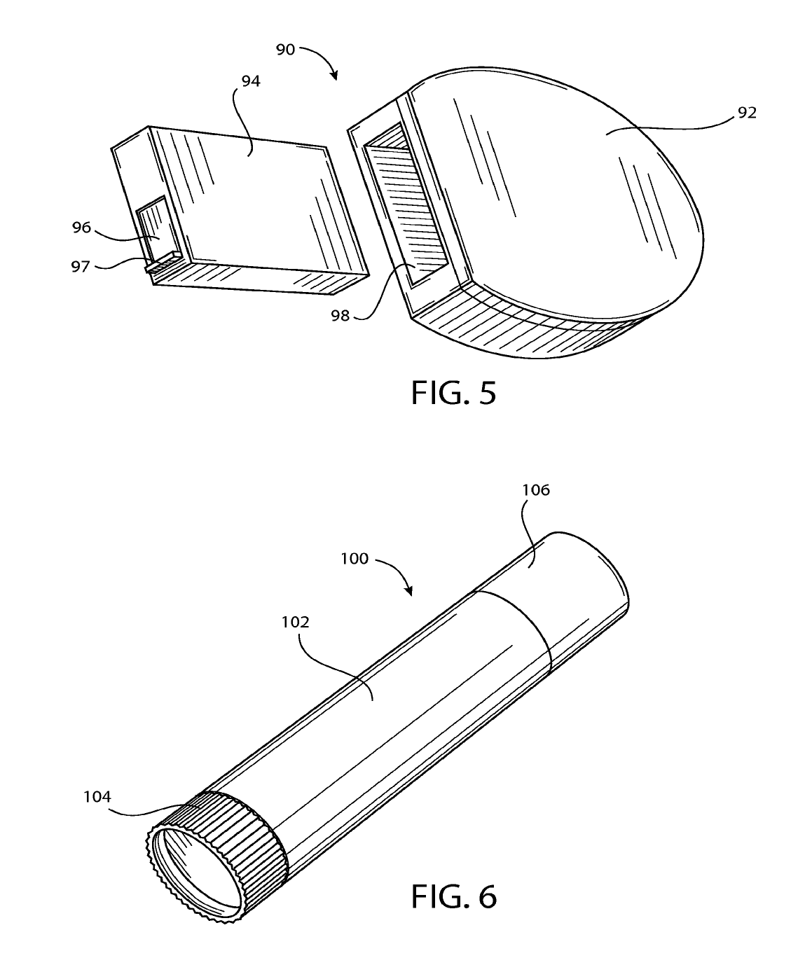

FIG. 5 shows an alternative embodiment of the invention 90. Security device 90 comprises a case 94 containing all of the electronics of the invention, including the central processor, location module, confirmation indicator(s), transceiver and power source. Embodiment 90 also includes an outer concealment case 92. Concealment case 92 is designed to look like a common item found in a purse or pocket. Concealment case 92 may be designed to look like a make-up case. Alternatively, concealment case 92 may look like a pendant, amulet, brooch or other decorative item. Preferably, a variety of concealment cases are available to suit the aesthetic tastes of different operators. The case 94 fits within cavity 98 of the concealment case, disguising the true nature of the device. This assists in preventing an assailant from identifying the nature of the device and discovering that an alert signal has been or may be sent.

Case 94 also includes a slidable trigger cover 96. slidable cover 96 covers the trigger so that it may not be accidentally depressed. This prevents accidental activation of the trigger and accidental transmission of an alert signal. Because this embodiment includes a trigger cover, a plurality of steps is required to activate the trigger. First the trigger cover 96 must be slid to the side and then the trigger must be depressed for a predetermined amount of time. Cover 96 is preferably held in place by any of a number of mechanism known in the art to snap a cover into place and may be pushed back by engaging tab 97. Sliding the cover and depressing the trigger may be accomplished with one hand. The design reduces the likelihood of an accidental transmission of an alert signal while still providing for a simple method of activating the trigger.

FIG. 6 shows another alternative embodiment of the invention 100. Embodiment 100 includes a case 102 designed to look like a common item in a purse or pocket. In this particular embodiment, case 102 is cylindrical and has the appearance of a stick of lip balm. This embodiment 100 includes a trigger 104 that is activated by twisting a predetermined number of times. Cap 106 enhances the deceptive appearance of the device by covering a recharging jack or any other components desirably hidden. This embodiment includes a vibrator as the confirmation indicator. Those skilled in the art will appreciate that the device may be similarly designed to appear as a lipstick tube or other similar object.

FIGS. 5 and 6 show embodiments disguised to look like common items. However, the device 10 may simply be a key fob. Kidnappers and other malfeasors have become aware cell phones may be used to signal others of the bearer's situation. As a result, a malfeasor may take, destroy or otherwise dispose of a victim's cell phone. A watch having the extra circuitry may be bulky and thus inconspicuous as a safety device. Thus, the device 10 of the present invention appears to be an innocuous key fob that may go unnoticed by an assailant.

Those skilled in the art may appreciate that embodiments of aspects of the invention may be practiced utilizing a smart phone application. This may be preferable in some situations. However, a kidnapper or other malfeasor will likely disable, destroy or dispose of a smart phone, or any other phone to prevent a victim from seeking help. A key fob, trinket or other object may not raise suspicion and thus may be more effective in an emergency situation.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A personal security system comprising:
a security device having a control module, a transceiver in communication with the control module, the transceiver operable for sending and receiving signals, a trigger in communication with the control module, the trigger operable to actuate transmission of a signal by the transceiver, a location module in communication with the control module, the location module identifying a location of the security device, a haptic signaling module and at least one a microphone and a camera, and an outer casing that does not have the appearance of a cellular phone, a pager, a watch or other communications device;
a monitoring station capable of generating an alert upon detecting one or more of the occurrences selected from the group consisting of a) an alert signal is received from the device, b) there is a substantial change in the speed of the device, c) the device enters a geographic region that has been cordoned off, d) the device does not provide the predetermined automated periodic check-in signal, and e) the device signals that a particular sound, word or speech pattern has been detected by the microphone, wherein the monitoring station is operated by one or more of a monitoring agent and a monitoring software, and wherein the monitoring station is capable of transmitting a signal to the security device which actuates a confirmation indicator selected from the group consisting of a haptic signaling device, an audio speaker, and a light.

2. The security system of claim 1, wherein the transceiver of the security device sends an alert signal including a device identifier, a location of the security device to the monitoring station and activates the haptic signaling module upon actuation of the trigger.

3. The security system of claim 1, wherein the transceiver of the security device sends an alert signal including a device identifier to the monitoring station upon actuation of the trigger, and the monitoring station subsequently begins monitoring the location, speed and audio signal from the security device.

4. The security system of claim 1 wherein the trigger is activated by impinging upon it in a predetermined pattern selected from the group of depressing the trigger for 3-5 seconds, depressing the trigger until a haptic signal is provided and depressing the trigger three times in succession.

5. The security system of claim 1 wherein the security device further comprises an accelerometer.

15. A method for summoning emergency assistance, comprising:
providing a security device comprising a location module, a device identifier module, a transceiver, a trigger, a confirmation indicator and a microphone; activating the trigger, wherein activation of the trigger actuates the transceiver to send an alert signal including a security device identity, a security device location and an audio signal to a monitoring station;
transmitting a receipt signal form the monitoring station to the transceiver; and actuating the confirmation indicator upon receipt of the receipt signal.

16. The method of claim 15, further comprising contacting an emergency assistance provider.

18. The method of claim 15, wherein activating the trigger includes depressing the trigger for a predetermined length of time.

19. The method of claim 15, wherein activating the trigger includes depressing the trigger until the security device receives the receipt signal.

20. A method for monitoring an individual comprising:
providing the individual a security device having a control module, a transceiver in communication with the control module, the transceiver operable for sending and receiving signals, a trigger in communication with the control module, the trigger operable to actuate transmission of a signal by the transceiver, a location module in communication with the control module, the location module identifying a location of the security device, a haptic signaling module and at least one a microphone and a camera, and an outer casing that does not have the appearance of a cellular phone, a pager, a watch or other communications device;
providing a monitoring station that sends an alert upon occurrence of at least one event selected from the group consisting of entry into a particular geographic region, the device traveling at a speed in excess of a predetermined maximum, distance from a particular location, recognition of an audio signal and failure of the security device to transmit a signal at a given predetermined interval, wherein the monitoring station includes at least one of a computer having specialized software and a monitoring agent.
